(19) United States
(12) Patent Application Publication
(10) Pub. No.: US 2012/0193835 A1
(43) Pub. Date: Aug. 2, 2012

(54) METHOD FOR PRODUCING LAMINATE

(75) Inventors: Yoshinori Suzuki, Tokyo (JP); Hiroyuki Sato, Tokyo (JP)

(73) Assignee: KUREHA CORPORATION, Tokyo (JP)

(21) Appl. No.: 13/496,732

(22) PCT Filed: Sep. 7, 2010
(86) PCT No.: PCT/JP2010/065298

§ 371 Date: Apr. 10, 2012

(30) Foreign Application Priority Data
Sep. 16, 2009 (JP) 2009-214618

(51) Int. Cl. C08L 67/04; B29C 55/02; B29C 49/00; B29C 47/04; B29C 71/02

(52) U.S. Cl. 264/459; 524/599; 264/176.1; 264/236; 264/291

(57) ABSTRACT

A method for producing a laminate, including a polymerization step of synthesizing a polyglycolic acid-based resin at a temperature of 200 to 220° C.; a mixing step of mixing 100 parts by mass of the polyglycolic acid-based resin with 0.016 parts by mass or more of a heat stabilizer under a condition that a highest temperature is between 275° C. and 295° C., thereby preparing a polyglycolic acid-based resin composition; and a forming step of forming the polyglycolic acid-based resin composition at a temperature of 230 to 265° C., thereby fabricating a laminate including a layer made of the polyglycolic acid-based resin composition.

### TECHNICAL FIELD

The present invention relates to a method for producing a laminate comprising a layer made of a polyglycolic acid-based resin composition.

### BACKGROUND ART

Polyglycolic acid is excellent in microbial degradability and hydrolyzability, and hence has attracted attention as a biodegradable polymer material having a reduced load on the environment. The polyglycolic acid is also excellent in gas-barrier properties, heat resistance, and mechanical strength. However, although films of such polyglycolic acid are excellent in mechanical strength, the mechanical strength is not necessarily sufficient when the film is used as a polyglycolic acid single layer. In addition, moisture resistance and economic efficiency are also insufficient. For these reasons, in general, a polyglycolic acid layer is often used in combination with another resin layer in a multilayer form.

For example, Japanese Unexamined Patent Application Publication No. 2003-20344 (PTL 1) discloses that a multilayer hollow container can be formed as follows. Specifically, polyglycolic acid is synthesized by ring-opening polymerization of glycolide at a temperature of approximately 120° C. to approximately 250° C., and a thermoplastic resin material is prepared by melt-kneading the obtained polyglycolic acid with various additives such as a heat stabilizer at a cylinder temperature of 150 to 255° C. Then, a multilayer preform comprising a polyglycolic acid layer and a different thermoplastic resin layer is formed by co-injecting the thermoplastic resin material with the different thermoplastic resin at a temperature of generally 150 to 255° C., and the multilayer hollow container is formed by blow molding the multilayer preform. The thus formed multilayer hollow container of the layer mainly containing polyglycolic acid and the different thermoplastic resin layer is excellent in gas-barrier properties, mechanical strength, and water resistance. However, delamination (interlayer peeling) caused by impact occurs between the layer mainly containing polyglycolic acid and the different thermoplastic resin layer in some cases. Hence, there is room for further improvement in delamination resistance (peeling resistance).

Meanwhile, International Application Japanese-Phase Publication No. 2005-526642 (PTL 2) discloses a multilayer stretch-molded article obtained by synthesizing a polyglycolic acid copolymer by ring-opening copolymerization of glycolide at a temperature of 30 to 300° C., applying a thermal history at a temperature of approximately 210 to 280° C. to the polyglycolic acid copolymer, then fabricating a laminate by co-extrusion, co-injection, or the like with a different thermoplastic resin, and stretching the laminate. In Example 8 of PTL 2, particularly, a multilayer hollow molded article was produced by preparing a copolymer by polymerization of glycolide and lactide at 170° C., melt-kneading the copolymer and a phosphite-based antioxidant at a temperature of 220 to 240° C., then co-injecting the melt kneaded product with polyethylene terephthalate at 270° C. to thereby fabricating a U-shaped parison, and stretch-blow-molding the parison.

In the thus produced multilayer hollow molded article, delamination (interlayer peeling) caused by impact was less likely to occur.

### CITATION LIST

### Patent Literature

[PTL 1] Japanese Unexamined Patent Application Publication No. 2003-20344

[PTL 2] International Application Japanese-Phase Publication No. 2005-526642

### SUMMARY OF INVENTION

### Technical Problem

The multilayer stretch-formed article described in PTL 2 has excellent resistance to delamination caused by impact immediately after the production. However, the multilayer stretch-formed article has a problem that delamination occurs when the multilayer stretch-formed article is stored for a long term.

The present invention has been made in view of the problem of the conventional techniques, and an object of the present invention is to provide a method for producing a laminate in which both delamination caused by impact and delamination during long-term storage are less likely to occur, and of which water resistance is excellent.

### Solution to Problem

The present inventors have conducted earnest study to achieve the above object. As a result, the present inventors have found that a laminate in which both delamination caused by impact (impact delamination) and delamination during long-term storage are less likely to occur between a polyglycolic acid-based resin layer and an adjacent layer, and of which water resistance is excellent can be obtained, when the crystallization temperature of a polyglycolic acid-based resin composition is lowered, and a thermal history experienced by the polyglycolic acid-based resin composition during forming is reduced, in producing a laminate comprising a polyglycolic acid-based resin layer. The finding has lead to the completion of the present invention.

Specifically, the method for producing a laminate of the present invention comprises:

a polymerization step of synthesizing a polyglycolic acid-based resin at a temperature of 200 to 220° C.;

a mixing step of mixing 100 parts by mass of the polyglycolic acid-based resin with 0.016 parts by mass or more of a heat stabilizer under a condition that a highest temperature is between 275° C. and 295° C., thereby preparing a polyglycolic acid-based resin composition; and

a forming step of forming the polyglycolic acid-based resin composition at a temperature of 230 to 265° C., thereby fabricating a laminate comprising a layer made of the polyglycolic acid-based resin composition.

In the forming step, the forming is preferably co-extrusion molding or co-injection molding of the polyglycolic acid-based resin composition with a different thermoplastic resin, and the different thermoplastic resin is more preferably at least one thermoplastic resin selected from the group consisting of polyester-based resins, polyolefin-based resins, polystyrene-based resins, polyvinyl chloride-based resins, polyvinylidene chloride-based resins, polyurethane-based resins, ethylene·vinyl alcohol-based resins, (meth)acrylic acid-based resins, nylon-based resins, sulfide-based resins, and polycarbonate-based resins.

In addition, the method for producing a laminate of the present invention preferably further comprises a heat treatment step of subjecting the laminate obtained in the forming step to a heat treatment. In the heat treatment step, stretch forming and/or blow forming can be conducted simultaneously.

Note that although it is not exactly clear why not only impact delamination but also delamination during long-term storage are less likely to occur in the laminate obtained by the production method of the present invention, and water resistance of the laminate is also excellent, the present inventors speculates as follows. Specifically, when a polyglycolic acid-based resin is synthesized at a predetermined polymerization temperature, and the polyglycolic acid-based resin is mixed with a heat stabilizer at a predetermined highest temperature, the crystallization temperature of the polyglycolic acid-based resin composition is lowered, and the crystallization rate is lowered. When a primary forming such as co-injection molding is conducted by use of such a polyglycolic acid-based resin composition having a low crystallization rate, an amorphous laminate is obtained. Presumably, the heating during a subsequently conducted secondary forming such as stretch forming results in formation of a layer made of a uniformly crystallized polyglycolic acid-based resin, so that a layer having a smooth surface can be fabricated. As a result, presumably, the adhesion between the layer made of the polyglycolic acid-based resin composition and the different layer is improved, so that the occurrence of the impact delamination is suppressed.

In addition, the lowering of the crystallization temperature enables the temperature for forming the polyglycolic acid-based resin composition to be set low, so that the thermal history experienced by the polyglycolic acid-based resin composition during the forming can be reduced, and the pyrolysis of the polyglycolic acid-based resin composition during the forming is suppressed. As a result of this, presumably, the water resistance of the layer made of the polyglycolic acid-based resin composition is improved.

Moreover, the laminate obtained by the production method of the present invention is excellent in the adhesion between the layer made of the polyglycolic acid-based resin composition and the different layer, and moreover the pyrolysis of the polyglycolic acid-based resin composition during the forming is suppressed. Because of this, presumably, the delamination during long-term storage becomes less likely to occur between the layer made of the polyglycolic acid-based resin composition and the different layer.

### Advantageous Effects of Invention

The present invention makes it possible to obtain a laminate in which both impact delamination and delamination during long-term storage are less likely to occur between a layer made of a polyglycolic acid-based resin composition and an adjacent layer and of which water resistance is excellent.

### DESCRIPTION OF EMBODIMENTS

Hereinafter, the present invention will be described in detail on the basis of preferred embodiments thereof.

A method for producing a laminate of the present invention comprises: a polymerization step of synthesizing a polyglycolic acid-based resin (hereinafter referred to as a “PGA-based resin”); a mixing step of mixing the PGA-based resin with a heat stabilizer, thereby preparing a polyglycolic acid-based resin composition (hereinafter referred to as a “PGA-based resin composition”); and a forming step of forming the PGA-based resin composition, thereby fabricating a laminate comprising a layer (hereinafter referred to as a “PGA-based resin layer”) made of the PGA-based resin composition. In addition, the method for producing a laminate of the present invention may comprise a heat treatment step of subjecting the laminate obtained as described above to a heat treatment. The heat treatment causes the PGA-based resin to crystallize, so that characteristics of a crystallized PGA-based resin, such as gas-barrier properties and water resistance, are imparted to the laminate.

<Polymerization Step>

First, the polymerization step according to the present invention is described. In this step, a glycolic acid homopolymer (hereinafter referred to as a “PGA homopolymer”) constituted of only the glycolic acid repeating unit represented by the following formula (1):

—[O—CH₂—C (═O) ]—

or a polyglycolic acid copolymer (hereinafter referred to as a “PGA copolymer”) having the glycolic acid repeating unit is synthesized by use of glycolic acid or a derivative thereof as a raw material monomer.

In the polymerization step according to the present invention, the PGA-based resin such as the glycolic acid homopolymer or the polyglycolic acid copolymer is synthesized by polymerizing the glycolic acid or the derivative thereof at a polymerization temperature of 200 to 220° C. If the polymerization temperature exceeds the upper limit, the PGA-based resin becomes likely to be colored, or pyrolyzed. Meanwhile, if the polymerization temperature is lower than the lower limit, the crystallization temperature of the PGA-based resin composition is likely to be high. When a laminate fabricated by forming, at 270° C. or above, such a PGA-based resin composition having a high crystallization temperature is subjected to a heat treatment to be described later, the water resistance of the laminate is not improved, and moreover delamination occurs during long-term storage. This is caused presumably because the PGA-based resin composition experiences a large thermal history and is pyrolyzed during the forming. Meanwhile, when a PGA-based resin composition having a high crystallization temperature is formed at a temperature of 230° C. to 265° C., the water resistance of the laminate is improved, but delamination occurs during long-term storage, and impact delamination occurs even immediately after the production. This is caused presumably because of the following reason. Specifically, since the thermal history experienced by the PGA-based resin composition is small during the forming, the pyrolysis is suppressed. However, when a primary forming is conducted at a low-temperature by use of a PGA-based resin composition having a high crystallization temperature, partial crystallization occurs in the PGA-based resin layer because of a fast crystallization rate. When the PGA-based resin partially crystallized as described above is subjected to a secondary forming, non-uniform crystal formation occurs, so that the smoothness of a surface (interface with a different layer) of the PGA-based resin layer is impaired, and the adhesion between the PGA-based resin layer and the different layer is lowered. Because of this, presumably, both delamination during long-term storage and impact delamination occur.

In the polymerization step, a polymerization time (mean residence time) is preferably 2 minutes to 50 hours, more preferably 3 minutes to 30 hours, and particularly preferably 5 minutes to 20 hours. If the polymerization time is shorter than the lower limit, the polymerization tends to proceed insufficiently. Meanwhile, if the polymerization time exceeds the upper limit, the PGA-based resin tends to be colored.

In the polymerization step according to the present invention, when glycolic acid is used as the raw material monomer, a PGA homopolymer is produced by dehydration polycondensation of glycolic acid. Meanwhile, when a glycolic acid alkyl ester, which is a derivative of glycolic acid, is used as the raw material monomer, a PGA homopolymer is produced by de-alcohol polycondensation of the glycolic acid alkyl ester. When glycolide, which is a cyclic ester of two molecules of glycolic acid, is used, a PGA homopolymer is produced by ring-opening polymerization of glycolide.

Moreover, in such a polycondensation reaction or a ring-opening polymerization reaction, a PGA copolymer can be synthesized by use of a comonomer in combination. Examples of the comonomer include cyclic monomers such as ethylene oxalate (i.e., 1,4-dioxane-2,3-dione), lactides, lactones (for example, β-propiolactone, β-butyrolactone, β-pivalolactone, γ-butyrolactone, δ-valerolactone, β-methyl-δ-valerolactone, ε-caprolactone, and the like), carbonates (for example, trimethylene carbonate and the like), ethers (for example, 1,3-dioxane and the like), ether esters (for example, dioxanone and the like), and amides (ε-caprolactam and the like); hydroxycarboxylic acids such as lactic acid, 3-hydroxypropanoic acid, 3-hydroxybutanoic acid, 4-hydroxybutanoic acid, and 6-hydroxycaproic acid, as well as alkyl esters thereof; and substantially equimolar mixtures of an aliphatic dial such as ethylene glycol or 1,4-butanediol with an aliphatic dicarboxylic acid such as succinic acid or adipic acid, or an alkyl ester thereof. These comonomers may be used alone or in combination of two or more. Of these comonomers, cyclic monomers and hydroxycarboxylic acids are preferable from the viewpoint of heat resistance.

In the polycondensation reaction or the ring-opening polymerization reaction, the amount of glycolic acid or a derivative thereof used is preferably 70% by mass or more, more preferably 80% by mass or more, further preferably 90% by mass or more, and particularly preferably 100% by mass, relative to total amount of all the raw material monomers. If the amount of glycolic acid or a derivative thereof used is less than the lower limit, the degree of crystallinity of the PGA-based resin tends to be lowered, so that the gas-barrier properties of the laminate tend to deteriorate.

Examples of catalysts used in the polycondensation reaction or the ring-opening polymerization reaction include known catalysts including tin-based compounds such as tin halides and organic tin carboxylates; titanium-based compounds such as alkoxy titanates; aluminum-based compounds such as alkoxy aluminums; zirconium-based compounds such as zirconium acetylacetonate; antimony-based compounds such as antimony halides and antimony oxides.

Methods for the polycondensation reaction or the ring-opening polymerization reaction are not particularly limited, but examples thereof include bulk polymerizations such as melt polymerization, solid-state polymerization, and combinations thereof; and the like. Of these methods, a method is preferable in which a raw material monomer is partially polymerized, and then the obtained partially polymerized product is solid-state polymerized as described in International Publication No. WO2007/086563, from the viewpoint that a PGA-based resin having a high molecular weight and being less colored can be obtained.

The thus obtained PGA-based resin has a weight average molecular weight of preferably 3×10⁴ to 80×10⁴, and more preferably 5×10⁴ to 50×10⁴. If the weight average molecular weight of the PGA-based resin is less than the lower limit, the mechanical strength of the laminate tends to be lowered. Meanwhile, if the weight average molecular weight exceeds the upper limit, it tends to be difficult to perform melt extrusion or injection molding. Note that the weight average molecular weight is a value determined by gel permeation chromatography (GPC) with respect to polymethyl methacrylate.

In addition, the PGA-based resin has a melt viscosity (temperature: 270° C., shear rate: 122 sec⁻¹) of preferably 50 to 3000 Pa·s, more preferably 100 to 2000 Pa·s, and particularly preferably 100 to 1000 Pa·s. If the melt viscosity is less than the lower limit, the mechanical strength of the laminate tends to be lowered. Meanwhile, if the melt viscosity exceeds the upper limit, it tends to be difficult to perform melt extrusion or injection molding.

<Mixing Step>

Next, the mixing step according to the present invention is described. In this step, a PGA-based resin composition is prepared by mixing the PGA-based resin with a heat stabilizer. At this time, an end-capping agent is preferably mixed in order to improve the water resistance of the laminate. Moreover, an inorganic filler, a plasticizer, a different thermoplastic resin, and the like described in Japanese Unexamined Patent Application Publication No. 2003-20344 may be mixed. Furthermore, it is also possible to mix various additives such as a light stabilizer, a moisture-proof agent, a waterproofing agent, a water repellent agent, a lubricating agent, a mold release agent, a coupling agent, a pigment, and a dye.

Examples of the heat stabilizer used in the present invention include phosphoric acid esters having a pentaerythritol skeletal structure such as cyclicneopentanetetraylbis(2,6-di-tert-butyl-4-methylphenyl) phosphite, cyclicneopentanetetraylbis(2,4-di-tert-butylphenyl) phosphite, and cyclicneopentanetetraylbis(octadecyl) phosphite; phosphoric acid alkyl esters and phosphorous acid alkyl esters having alkyl groups (preferably having 8 to 24 carbon atoms), such as mono- or di-stearyl acid phosphates and mixtures thereof; metal carbonates such as calcium carbonate and strontium carbonate; hydrazine-based compounds having a —CONHNH—CO— unit such as bis[2-(2-hydroxybenzoyl)hydrazine]dodecanoic acid and N,N′-bis[3-(3, 5-di-t-butyl-4-hydroxyphenyl)propionyl]hydrazine; triazole-based compounds such as 3-(N-salicyloyl)amino-1,2,4-triazole; triazine-based compounds; and the like. These heat stabilizers may be used alone or in combination of two or more.

In the present invention, the amount of the heat stabilizer added is 0.016 parts by mass or more relative to 100 parts by mass of the PGA-based resin. If the amount of the heat stabilizer added is less than the lower limit, the water resistance of the laminate is lowered because of a thermal history during the forming of the PGA-based resin composition, and delamination occurs during long-term storage. From such a viewpoint, the amount of the heat stabilizer added is preferably 0.020 parts by mass or more. Meanwhile, an upper limit of the amount of the heat stabilizer added is not particularly limited, but is preferably 10 parts by mass or less, more preferably 2 parts by mass or less, further preferably 1 part by mass or less, particularly preferably 0.5 parts by mass or less, and most preferably 0.1 parts by mass or less, relative to 100 parts by mass of the PGA-based resin. If the amount of the heat stabilizer added exceeds the upper limit, the heat stability tends to be saturated so that the effect corresponding to the increase in the added amount is less likely to be obtained. In addition, lubricity controllability tends to be lowered in forming processing, and the transparency of the laminate tends to be lowered.

Examples of the end-capping agent used in the present invention include carbodiimide compounds including monocarbodiimide and polycarbodiimide compounds such as N,N-2,6-diisopropylphenylcarbodiimide; oxazoline compounds such as 2,2′-m-phenylenebis(2-oxazoline), 2,2′-p-phenylenebis(2-oxazoline), 2-phenyl-2-oxazoline, and styrene·isopropenyl-2-oxazoline; oxazine compounds such as 2-methoxy-5,6-dihydro-4H-1,3-oxazine; epoxy compounds such as N-glycidylphthalimide, cyclohexene oxide, and triglycidyl isocyanurate; and the like. These end-capping agents may be used alone or in combination of two or more.

In the present invention, the amount of the end-capping agent added is preferably 0.01 parts by mass or more and 10 parts by mass or less, more preferably 0.1 parts by mass or more and 2 parts by mass or less, and particularly preferably 0.2 parts by mass or more and 1 part by mass or less, relative to 100 parts by mass of the PGA-based resin.

In the mixing step according to the present invention, the PGA-based resin, the heat stabilizer, and, if necessary, the end-capping agent and the like are mixed (preferably, melt kneaded) by use of mixing means such as a mixer, a continuous kneader, an extruder, or the like. At this time, these are mixed with each other while being heated such that a highest temperature can be between 275° C. and 295° C. (preferably between 275° C. and 290° C., and more preferably between 275° C. and 285° C.). If the highest temperature during the mixing exceeds the upper limit, the PGA-based resin composition becomes likely to be colored, or the PGA-based resin becomes likely to be pyrolyzed. Meanwhile, if the highest temperature during the heating is lower than the lower limit, the crystallization temperature of the PGA-based resin composition is likely to be high. When a laminate is fabricated at 270° C. or above by forming, at 270° C. or above, such a PGA-based resin composition having a high crystallization temperature, the water resistance of the laminate is not improved, and moreover delamination occurs during long-term storage. This is caused presumably because the PGA-based resin composition experiences a large thermal history and is pyrolyzed during the forming. Meanwhile, when a PGA-based resin composition having a high crystallization temperature is formed at a temperature of 230° C. to 265° C., the water resistance of the laminate is improved, but delamination occurs during long-term storage, and impact delamination occurs even immediately after the production. This is caused presumably because of the following reason. Specifically, since the thermal history experienced by the PGA-based resin composition is small during the forming, the pyrolysis is suppressed. However, when a primary forming is conducted at a low-temperature by use of a PGA-based resin composition having a high crystallization temperature, partial crystallization occurs in the PGA-based resin layer because of a fast crystallization rate. When the PGA-based resin partially crystallized as described above is subjected to a secondary forming, non-uniform crystal formation occurs, so that the smoothness of a surface (interface with a different layer) of the PGA-based resin layer is impaired, and the adhesion between the PGA-based resin layer and the different layer is lowered. Because of this, presumably, both delamination during long-term storage and impact delamination occur.

In the mixing step according to the present invention, a temperature history is not particularly limited, as long as the highest temperature falls within the above-described range. For example, when the mixing is performed by use of an extruder, the heating may be conducted at temperatures within the above-described range in the entire region from a supply port to a discharge port of the extruder. Alternatively, a heating temperature may be set such that the temperature becomes higher sequentially from a supply port of an extruder, and heating is conducted at a temperature within the above-described range at a point, and then the temperature becomes lower toward a discharge port.

As described above, a PGA-based resin composition having a lowered crystallization temperature can be obtained by mixing the PGA-based resin synthesized at the above-described polymerization temperature with the heat stabilizer under a condition that the highest temperature is within the above-described range, and, for example, a PGA-based resin composition having a crystallization temperature of 110 to 140° C. (preferably 115 to 135° C.) can be obtained. If the crystallization temperature of the PGA-based resin composition is lower than the lower limit, the gas-barrier properties of the laminate may deteriorate in some cases. Meanwhile, if the crystallization temperature exceeds the upper limit, the forming temperature in the forming step to be described later has to be set high, so that the water resistance of the laminate is not improved, and moreover delamination becomes likely to occur during long-term storage. This is caused presumably because the PGA-based resin composition experiences a large thermal history and is pyrolyzed during the forming.

<Drying Step>

In the present invention, the thus obtained PGA-based resin composition is preferably subjected to a heat treatment. This heat treatment makes it possible to reduce the glycolide content in the PGA-based resin composition, and makes it possible to suppress the lowering of the water resistance. A drying temperature is preferably 120 to 225° C., and more preferably 150 to 220° C. Meanwhile, a drying time is preferably 0.5 to 95 hours, and more preferably 1 to 48 hours.

<Forming Step>

Subsequently, the forming step according to the present invention is described. In this step, a laminate comprising a layer (hereinafter also referred to as a “PGA-based resin layer”) made of the PGA-based resin composition is fabricated by forming the PGA-based resin composition. Examples of the method for fabricating the laminate include the fusion bonding method in which the PGA-based resin composition is formed into a film, and the film is laminated on a different film as described in Japanese Unexamined Patent Application Publication No. 2003-20344; the lamination method in which the PGA-based resin composition is formed into a film, an adhesive agent is applied onto a surface of the PGA-based resin film or a different film, and these films are thermocompression-bonded with each other as described in Japanese Unexamined Patent Application Publication No. 2003-20344; the extrusion coating method in which a PGA-based resin layer is fabricated by extrusion-molding the PGA-based resin composition on a surface of a different film as described in Japanese Unexamined Patent Application Publication No. 2003-20344; the co-extrusion method or the co-injection method in which the PGA-based resin composition and a material to fabricate a different layer are co-extrusion molded or co-injection molded as described in Japanese Unexamined Patent Application Publication No. 2003-20344, Japanese Unexamined Patent Application Publication No. 2003-136657, International Application Japanese-Phase Publication No 2005-526642, and International Publication No. WO2006/107099; and the like. The co-extrusion method and the co-injection method are advantageous because forming processes are simple.

In the forming step according to the present invention, a forming temperature of the formed product of the PGA-based resin is 230 to 265° C. If the forming temperature of the PGA-based resin composition is lower than the lower limit, an unmelted material occurs, so that it becomes difficult to obtain a desired laminate. Meanwhile, if the forming temperature exceeds the upper limit, the PGA-based resin composition experiences a large thermal history during the forming, so that the water resistance of the laminate is not improved, and delamination becomes likely to occur during long-term storage, even when a PGA-based resin composition having a low crystallization temperature is used. This is caused presumably because the PGA-based resin composition experiences a large thermal history and is pyrolyzed during the forming. From such a viewpoint, the forming temperature of the PGA-based resin composition is preferably 230 to 260° C., more preferably 235 to 255° C., particularly preferably 235 to 250° C., and most preferably 235 to 245° C. Note that, in the present invention, the forming temperature is, for example, the temperature of a die in the case of extrusion molding, or the barrel temperature and the hot-runner temperature in the case of injection molding.

Examples of the material constituting the different film or the different layer used in the present invention include thermoplastic resins, paper, and the like. Moreover, in the present invention, an adhesive layer may be fabricated between layers of the laminate. Examples of the thermoplastic resin include polyester-based resins such as polyethylene terephthalate, polytrimethylene terephthalate, polyethylene naphthalate, polybutylene terephthalate, copolymers thereof, and polylactic acid; polyolefin-based resins such as polyethylene, polypropylene, and ethylene·propylene copolymers; polystyrene-based resins such as polystyrene and styrene·butadiene copolymers; polyvinyl chloride-based resins; polyvinylidene chloride-based resins; polyurethane-based resins; ethylene·vinyl alcohol-based resins; (meth)acrylic acid-based resins; nylon-based resins; sulfide-based resins; polycarbonate-based resins; and the like. These thermoplastic resins may be used alone or in combination of two or more. Of these thermoplastic resins, polyester-based resins are preferable, aromatic polyester-based resins in which at least one of the diol component and the dicarboxylic acid component is an aromatic compound are more preferable, and aromatic polyester-based resins obtained from an aromatic dicarboxylic acid are particularly preferable, from the viewpoint that a laminate can be obtained which has both desirable transparency and desirable gas-barrier property at satisfactory levels, which depend on the application.

A forming temperature for fabricating such a different film or such a different layer is appropriately set depending on the material constituting the different film or the different layer. For example, when polyethylene terephthalate (PET) is used as the material constituting the different film or the different layer, the forming temperature for fabricating the PET film or the PET layer is preferably 280 to 310° C., and more preferably 285 to 305° C. If the forming temperature of the PET film or the PET layer is lower than the lower limit, an unmelted material occurs, so that it tends to be difficult to obtain a desired laminate. Meanwhile, if the forming temperature exceeds the upper limit, coloration tends to occur, and it tends to be difficult to perform the forming because of lowered viscosity.

In the forming step, different layers are preferably fabricated on both sides of the PGA-based resin layer in order to improve the water resistance of the laminate. In addition, the constituent ratio of the PGA-based resin layer is preferably 1 to 10% by mass (the percentage is almost equal to the percentage by thickness) relative to the entire laminate. If the constituent ratio of the PGA-based resin layer is less than the lower limit, the gas-barrier properties of the laminate tend to deteriorate. Meanwhile, if the constituent ratio exceeds the upper limit, a large stress is required for stretch forming, and the transparency of the laminate tends to be lowered.

<Heat Treatment Step>

Next, the heat treatment step according to the present invention is described. In this step, the laminate obtained as described above is heated, so that the PGA-based resin composition forming the PGA-based resin layer is crystallized. Thus, characteristics of a PGA-based resin such as gas-barrier properties and water resistance are imparted to the laminate.

In the heat treatment, a heating temperature is preferably 50 to 200° C., and more preferably 60 to 150° C. If the heating temperature is lower than the lower limit, the crystallization tends to proceed insufficiently, so that gas-barrier properties and water resistance tend to be exhibited insufficiently. Meanwhile, if the heating temperature exceeds the upper limit, it tends to be difficult for the laminate to keep the shape thereof and to exhibit the physical properties, because the PGA-based resin layer is melt.

In addition, in the heat treatment step, the laminate can be subjected to stretch forming and/or blow forming simultaneously with the heat treatment. Methods for the stretch forming and the blow forming are not particularly limited, but it is possible to employ known methods described in Japanese Unexamined Patent Application Publication No. 2003-20344, Japanese Unexamined Patent Application Publication No. 2003-136657, International Application Japanese-Phase Publication No. 2005-526642, International Publication No. WO2006/107099, and the like.

The shape of the laminate obtained as described above is not particularly limited, but examples thereof include a film shape, a sheet shape, a hollow shape, and the like. In addition, by performing the stretch forming and/or the blow forming, laminates such as multilayer stretch-formed articles, multilayer blow-formed articles, and multilayer stretch-blow-molded articles can be obtained.

### EXAMPLES

Hereinafter, the present invention will be described more specifically on the basis of Examples and Comparative Examples. However, the present invention is not limited to Examples below. Note that physical properties of PGA resins and PGA resin compositions were measured by the following methods.

<Polymerization Reaction Ratio>

A predetermined amount of a PGA resin was added to dimethyl sulfoxide (manufactured by Kanto Chemical Co., Inc.) in which 4-chlorobenzophenone (manufactured by Kanto Chemical Co., Inc.) was dissolved as an internal standard substance at a predetermined concentration, and dissolved thereinto by heating. Then, the solution was cooled, and a precipitate was filtered. The filtrate was analyzed by a gas chromatograph (“GC-2010” manufactured by Shimadzu Corporation) under the conditions below, the glycolide content in the PGA resin was determined, and the polymerization reaction ratio was calculated.

(Analysis Conditions)

Column: TC-17 (0.25 mm in diameter×30 m)
Column temperature: the temperature was held at 150° C., then raised to 270° C., and held for a predetermined time.
Injection temperature: 180° C.
Detector: FID (hydrogen flame ionization detector, temperature 300° C.).

<Melting Point>

By use of a differential scanning calorimeter (“DSC30/TC15” manufactured by Mettler Toledo International Inc.), heating was conducted under a nitrogen stream, while the temperature was raised from −50° C. to 280° C. at 20° C/minute. The temperature at the maximum point of an endothermic peak due to melting during the heating was regarded as the melting point of the PGA resin. <Molecular Weight>

A transparent amorphous sheet was fabricated by melt-pressing a sufficiently dried PGA resin with a heat press at 275° C., and then immediately cooling the PGA resin. A sample solution was prepared by cutting out a sample from the amorphous sheet, and dissolving the sample into hexafluoroisopropanol (HFIP manufactured by DuPont) in which sodium trifluoroacetate (manufactured by Kanto Chemical Co., Inc.) was dissolved at a concentration of 5 mM. This sample solution was filtered through a membrane filter (made of PTFE, pore diameter: 0.1 μm), and then injected into a gel permeation chromatograph (“Shodex GPC-104” manufactured by Showa Denko K. K.). The number average molecular weight and the weight average molecular weight of the PGA resin were measured under the conditions below, and the polydispersity (=the weight average molecular weight/the number average molecular weight) was calculated. Note that the sample solution was injected into the GPC apparatus within 30 minutes after the amorphous sheet was dissolved.

(Analysis Conditions)

Columns: HFIP-606M (two columns), pre-column: HFIP-G (one column), these columns were connected in series.
Column temperature: 40° C.
Eluent: 5 mM sodium trifluoroacetate HFIP solution
Flow rate: 0.6 ml/minute
Detector: RI (differential refractive index detector)
Standard substance for molecular weight determination: standard polymethyl methacrylate (manufactured by Showa Denko K. K.).

<Crystallization Temperature>

A 200-μm sheet was fabricated by melt-pressing a sufficiently dried PGA resin composition with a heat press at 280° C. A piece in a predetermined amount was cut out from the sheet, and the cut-out piece was heated by use of a differential scanning calorimeter (“DSC30/TC15” manufactured by Mettler Toledo International Inc.) under a nitrogen stream, while the temperature was raised from −50° C. to 280° C. at 20° C/minute. After that, the piece was cooled to room temperature at 20° C/minute. The temperature at the maximum point of an exothermic peak due to crystallization during the cooling was regarded as the crystallization temperature of the PGA resin composition.

<Water Resistance>

A PGA resin layer was obtained by peeling off inner and outer layers of a bottle, and exposed to an atmosphere of a temperature of 50° C. and a humidity of 90% RH for a predetermined time. After the exposure, a piece in a predetermined amount was cut out from the PGA resin layer, and the cut-out piece was dissolved into 1 ml of dimethyl sulfoxide (special grade reagent manufactured by Kanto Chemical Co., Inc.) at 150° C. Then, the solution was cooled, and a precipitate was obtained. The molecular weight of the precipitates was measured by the same method as that for the above-described molecular weight measurement of the PGA resin, and the time taken for the weight average molecular weight to be lowered to 70000 was determined.

<Delamination Resistance>

(1) Initial stage (the presence or absence of the occurrence of impact delamination)

A bottle was filled with carbonated water at 4.2 atm, capped, and left at 23° C. for 24 hours, and then subjected to a pendulum impact test. Observation was made as to whether or not impact delamination occurred between an outer PET layer and a PGA resin layer. The impact test was conducted on 20 bottles, and the number of bottles in which no impact delamination occurred was counted.

(2) Long term (the presence or absence of the occurrence of delamination during long-term storage)

A bottle was filled with carbonated water at 4.2 atm, capped, and stored in a constant temperature and humidity chamber at a temperature of 30° C. and a humidity of 80% RH for 2 months. After the storage, the appearance of the bottle was observed. The bottle in which no delamination occurred during the storage was determined as “A”, and the bottle in which delamination occurred was determined as “B”.

<Synthesis of PGA Resins>

### Synthesis Example 1

In accordance with the method described in International Publication No. WO2007/086563, a high purity glycolide (manufactured by Kureha Corporation) as a raw material monomer, 1-dodecanol as an initiator in an amount which was 0.2% by mole relative to that of the glycolide, and tin dichloride as a catalyst in an amount which was 30 ppm relative to that of the glycolide were introduced into a reactor, and continuously polymerized with a mean residence time of 20 minutes, while the reactor was controlled at a temperature of 200 to 210° C. The obtained polymerization product was taken out in a particulate form, and the polymerization product was further subjected to solid-state polymerization at 170° C. for 3 hours, while being stirred under a nitrogen atmosphere. As a result, the final polymerization reaction ratio reached 99% or higher, and a granular PGA resin was obtained which had a melting point of 222° C., a weight average molecular weight of 20×10⁴, and a polydispersity (=the weight average molecular weight/the number average molecular weight) of 2.0.

### Synthesis Example 2

The glycolide as a raw material monomer and 1-dodecanol as an initiator in an amount which was 0.2% by mole relative to that of the glycolide were introduced, and melted by heating. Then, tin dichloride as a catalyst was added thereto in an amount which was 30 ppm relative to that of the glycolide, and sufficient mixing was conducted. The obtained mixture was introduced into a cylindrical multi-tubular reaction vessel made of stainless steel (SUS304), and subsequently an opening portion in an upper portion of the reactor was tightly sealed with a metal plate made of stainless steel (SUS304). The reaction vessel had jackets on a side surface and a bottom surface thereof. A ring-opening polymerization of the glycolide was conducted by forcibly circulating a heating medium oil at 170° C. through the jackets for 7 hours.

After that, the reaction vessel was cooled by cooling the heating medium oil, and subsequently a lump of a PGA resin was taken out by detaching the metal plate in the upper portion of the reactor, and inverting the reaction vessel (recovery: approximately 100%). Note that the final polymerization reaction ratio was 99% or higher.

The obtained lump of the PGA resin was subjected to a two-stage grinding process (coarse grinding and medium grinding). Thus, a granular PGA resin was obtained which had a melting point of 222° C., a weight average molecular weight of 20×10⁴, and a polydispersity of 2.0.

### Example 1

<Preparation of PGA Resin Composition>

A PGA resin composition was prepared by use of a twin-screw kneader-extruder (“TEM41SS” manufactured by Toshiba Machine Co., Ltd.). The twin-screw kneader-extruder was equipped with electric heaters capable of independently controlling temperatures of 13 regions. The temperatures were controlled such that the highest temperature of the cylinder of the extruder was 275° C.

The granular PGA resin synthesized at a polymerization temperature of 200 to 210° C. in Synthesis Example 1 was continuously fed into the twin-screw kneader-extruder. At this time, a heat stabilizer (“Adeka Stab AX-71” manufactured by Asahi Denka Co., Ltd.) at a ratio of 0.020 parts by mass relative to 100 parts by mass of the PGA resin and N,N-2,6-diisopropylphenylcarbodiimide (“DIPC” manufactured by Kawaguchi Chemical Industry Co,. Ltd.) as an end-capping agent at a ratio of 0.3 parts by mass relative to 100 parts by mass of the PGA resin were continuously fed in molten states, and melt kneading was conducted. A strand discharged from dies of the extruder was cooled, and cut with a pelletizer. Thus, a pelletized PGA resin composition was obtained. The obtained pellets were subjected to a heat treatment at 170° C. for 17 hours. The PGA resin composition had a glycolide content of 0.1% by mass or less and a crystallization temperature of 134° C.

<Co-Injection Molding>

Next, a colorless transparent bottle preform (hereinafter referred to as a “three-layer preform”) comprising three layers of PET/PGA/PET (amount of PGA filled: 3% by mass) was fabricated. For the fabrication, the PGA resin composition was used as a resin for an intermediate layer; polyethylene terephthalate (“CB602S” manufactured by Far Eastern Textile Limited; weight average molecular weight: 2×10⁴; melt viscosity (at a temperature of 290° C. and a shear rate of 122 sec⁻¹): 550 Pa·s; glass transition temperature: 75° C.; and melting point: 249° C.) was used as a resin for inner and outer layers; and a co-injection molding machine capable of independently controlling the temperatures of barrels and runners for the layers was used. At this time, the temperatures of the barrel and the runner for the intermediate layer were set to 235° C., and the temperatures of the barrels and the runners for the inner and outer layers were set to 290° C.

<Stretch-Blow Molding>

The obtained three-layer bottle preform was blow formed at 110° C. by use of a stretch-blow molding machine (manufactured by Frontier Inc.). Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Example 2

A pelletized PGA resin composition was obtained, and then subjected to a heat treatment, in the same manner as in Example 1, except that the temperatures were controlled such that the highest temperature of the cylinder of the twin-screw kneader-extruder used for the preparation of the PGA resin composition was 280° C. The PGA resin composition had a glycolide content of 0.1% by mass or less, and a crystallization temperature of 123° C.

Next, co-injection molding and stretch-blow molding were conducted in the same manner as in Example 1, except that this pelletized PGA resin composition was used. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Example 3

A pelletized PGA resin composition was obtained, and then subjected to a heat treatment, in the same manner as in Example 2, except that the amount of the heat stabilizer fed was changed to 0.030 parts by mass relative to 100 parts by mass of the PGA resin. The PGA resin composition had a glycolide content of 0.1% by mass or less and a crystallization temperature of 118° C.

Next, co-injection molding and stretch-blow molding were conducted in the same manner as in Example 1, except that this pelletized PGA resin composition was used. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Example 4

Co-injection molding and stretch-blow molding were conducted in the same manner as in Example 1, except that the temperatures of the barrel and the runner for the intermediate layer were changed to 250° C. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 1

A pelletized PGA resin composition was obtained, and then subjected to a heat treatment, in the same manner as in Example 1, except that the granular PGA resin synthesized at a polymerization temperature of 170° C. in Synthesis Example 2 was used, and that the temperatures were controlled such that the highest temperature of the cylinder of the twin-screw kneader-extruder used for the preparation of the PGA resin composition was 265° C. The PGA resin composition had a glycolide content of 0.1% by mass or less and a crystallization temperature of 156° C.

Next, co-injection molding and stretch-blow molding were conducted in the same manner as in Example 1, except that this pelletized PGA resin composition was used. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 2

Co-injection molding and stretch-blow molding were conducted in the same manner as in Comparative Example 1, except that the temperatures of the barrel and the runner for the intermediate layer of the co-injection molding machine used for the co-injection molding were changed to 280° C. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 3

A pelletized PGA resin composition was obtained, and then subjected to a heat treatment, in the same manner as in Example 1, except that the granular PGA resin synthesized at a polymerization temperature of 170° C. in Synthesis Example 2 was used. The PGA resin composition had a glycolide content of 0.1% by mass or less and a crystallization temperature of 147° C.

Next, co-injection molding and stretch-blow molding were conducted in the same manner as in Example 1, except that this pelletized PGA resin composition was used, and that the temperatures of the barrel and the runner for the intermediate layer were changed to 270° C. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 4

A pelletized PGA resin composition was obtained, and then subjected to a heat treatment, in the same manner as in Example 1, except that the amount of the heat stabilizer fed was changed to 0.015 parts by mass relative to 100 parts by mass of the PGA resin. The PGA resin composition had a glycolide content of 0.1% by mass or less and a crystallization temperature of 136° C.

Next, co-injection molding and stretch-blow molding were conducted in the same manner as in Example 1, except that this pelletized PGA resin composition was used. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 5

A pelletized PGA resin composition was obtained, and then subjected to a heat treatment, in the same manner as in Example 1, except that the temperatures were controlled such that the highest temperature of the cylinder of the twin-screw kneader-extruder used for the preparation of the PGA resin composition was 265° C. The PGA resin composition had a glycolide content of 0.1% by mass or less and a crystallization temperature of 153° C.

Next, co-injection molding and stretch-blow molding were conducted in the same manner as in Example 1, except that this pelletized PGA resin composition was used. Thus, a colorless transparent bottle comprising three layers of PET/PGA/PET (amount of PGA filled: 3% by mass) was obtained. The water resistance and the delamination resistance of the obtained bottle were evaluated. Table 1shows these results.

### Comparative Example 6

Co-injection molding and stretch-blow molding were conducted in the same manner as in Comparative Example 5, except that the temperatures of the barrel and the runner for the intermediate layer were changed to 280° C. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

### Comparative Example 7

Co-injection molding and stretch-blow molding were conducted in the same manner as in Example 1, except that the temperatures of the barrel and the runner for the intermediate layer were changed to 270° C. Thus, a colorless transparent bottle comprising three layers of PET/PGA/PET (amount of PGA filled: 3% by mass) was obtained. The water resistance and the delamination resistance of the obtained bottle were evaluated. Table 1 shows these results.

TABLE 1

| | | Content of | | | Injection molding | Bottle properties | | |
|---|---|---|---|---|---|---|---|---|
| | Polymerization | heat stabilizer | Highest temp. | Crystallization | temperature of | Water | Delamination | |
| | temperature | (parts by | during mixing | temperature | PGA resin layer | resistance | resistance | |
| | (° C.) | mass) | (° C.) | (° C.) | (° C.) | (hour) | Impact | Storage |
| Ex. 1 | 200 to 210 | 0.020 | 275 | 134 | 235 | 182 | 20 | A |
| Ex. 2 | 200 to 210 | 0.020 | 280 | 123 | 235 | 180 | 20 | A |
| Ex. 3 | 200 to 210 | 0.030 | 280 | 118 | 235 | 179 | 20 | A |
| Ex. 4 | 200 to 210 | 0.020 | 275 | 134 | 250 | 175 | 20 | A |
| Comp. Ex. 1 | 170 | 0.020 | 265 | 156 | 235 | 185 | 7 | B |
| Comp. Ex. 2 | 170 | 0.020 | 265 | 156 | 280 | 128 | 13 | B |
| Comp. Ex. 3 | 170 | 0.020 | 275 | 147 | 270 | 149 | 19 | B |
| Comp. Ex. 4 | 200 to 210 | 0.015 | 275 | 136 | 235 | 173 | 20 | B |
| Comp. Ex. 5 | 200 to 210 | 0.020 | 265 | 153 | 235 | 182 | 9 | B |
| Comp. Ex. 6 | 200 to 210 | 0.020 | 265 | 153 | 280 | 126 | 14 | B |
| Comp. Ex. 7 | 200 to 210 | 0.020 | 275 | 134 | 270 | 146 | 19 | B |

As is apparent from the results shown in Table 1, it was found that the crystallization temperatures were low, when the PGA resin compositions were prepared by the polymerization method and the mixing method according to the present invention (Examples 1 to 4 and Comparative Examples 4 and 7). Meanwhile, the crystallization temperatures were high, when the polymerization was conducted at a temperature lower than the polymerization temperature according to the present invention (Comparative Examples 1 to 3) and/or when the PGA resin compositions were prepared at a highest temperature during the mixing being lower than the temperature range according to the present invention (Comparative Examples 1, 2, 5, and 6).

In addition, when such PGA resin compositions were co-injection molded at 270° C. (Comparative Examples 3 and 7), in the multilayer hollow containers (bottles), impact delamination was less likely to occur, but delamination during long-term storage occurred irrespective of the crystallization temperature of the PGA resin composition.

Meanwhile, when the PGA resin compositions having a low crystallization temperature were co-injection molded at a low temperature (Examples 1 to 4), the water resistance of the multilayer hollow containers (bottles) was improved as compared with in Comparative Examples 3 and 7, and the occurrence of impact delamination and the occurrence of delamination during long-term storage were both suppressed.

On the other hand, when the PGA resin compositions having a high crystallization temperature were co-injection molded at a low temperature (Comparative Examples 1 and 5), the obtained multilayer hollow containers (bottles) had water resistance at the same level as in Examples 1 to 4, but both impact delamination and delamination during long-term storage occurred.

In addition, when the PGA resin compositions having a high crystallization temperature were co-injection molded at a temperature higher than the forming temperature according to the present invention (Comparative Examples 2 and 6), the water resistance of the multilayer hollow containers (bottles) was lowered as compared with in Examples 1 to 4, and impact delamination and delamination during long-term storage occurred.

Moreover, when the content of the heat stabilizer was low (Comparative Example 4), the occurrence of impact delamination of the multilayer hollow container (bottle) was suppressed, but the water resistance thereof was lowered, and delamination during long-term storage also occurred.

### INDUSTRIAL APPLICABILITY

As described above, in producing a laminate comprising a polyglycolic acid-based resin layer, the present invention makes it possible to lower the crystallization temperature of a polyglycolic acid-based resin composition, and to reduce the thermal history experienced by the polyglycolic acid-based resin composition during forming.

Accordingly, in the laminate produced according to the present invention, both delamination caused by impact and delamination during long-term storage are less likely to occur between the polyglycolic acid-based resin layer and an adjacent layer, and water resistance of the laminate is excellent. Hence, the laminate is useful as a multilayer film, a multilayer sheet, a multilayer hollow container, or the like.

1. A method for producing a laminate, comprising:
a polymerization step of synthesizing a polyglycolic acid-based resin at a temperature of 200 to 220° C.;
a mixing step of mixing 100 parts by mass of the polyglycolic acid-based resin with 0.016 parts by mass or more of a heat stabilizer under a condition that a highest temperature is between 275° C. and 295° C., thereby preparing a polyglycolic acid-based resin composition; and
a forming step of forming the polyglycolic acid-based resin composition at a temperature of 230 to 265° C., thereby fabricating a laminate comprising a layer made of the polyglycolic acid-based resin composition.

2. The method for producing a laminate according to claim 1, wherein the forming in the forming step is co-extrusion molding or co-injection molding of the polyglycolic acid-based resin composition with a different thermoplastic resin.

3. The method for producing a laminate according to claim 2, wherein the different thermoplastic resin is at least one thermoplastic resin selected from the group consisting of polyester-based resins, polyolefin-based resins, polystyrene-based resins, polyvinyl chloride-based resins, polyvinylidene chloride-based resins, polyurethane-based resins, ethylene·vinyl alcohol-based resins, (meth)acrylic acid-based resins, nylon-based resins, sulfide-based resins and polycarbonate-based resins.

4. The method for producing a laminate according to claim 1, further comprising a heat treatment step of subjecting the laminate obtained in the forming step to a heat treatment.

5. The method for producing a laminate according to claim 4, wherein, in the heat treatment step, the laminate is subjected to stretch molding and/or blow molding simultaneously with the heating.
